(19) United States
(12) Patent Application Publication
(10) Pub. No.: US 2019/0127158 A1
(43) Pub. Date: May 2, 2019

(54) FLOATING SPLIT BUTTERFLY VALVE

(71) Applicant: BRINOX D.O.O., Medvode (SI)

(72) Inventor: Slavislav SAVIC, Ljubljana (SI)

(73) Assignee: BRINOX D.O.O., Medvode (SI)

(21) Appl. No.: 16/093,513

(22) PCT Filed: Apr. 10, 2017
(86) PCT No.: PCT/SI2017/000006

§ 371 Date: Oct. 12, 2018

(30) Foreign Application Priority Data
Apr. 14, 2016 (SI) P-201600101

(51) Int. Cl. B65G 69/18; F16K 1/22; F16K 27/02

(52) U.S. Cl. CPC B65G 69/183; F16K 27/0218; F16K 1/223; F16K 1/222

(57) ABSTRACT

The object of the invention is a floating split butterfly valve that allows connection of two processing devices or containers in a way that one of the devices (e. g. a transport device or a container) is closed by one half of the valve (passive part) while the other device (e. g. a stable device or a container) is closed by another half of the valve (active part), wherein the material (powder and/or liquid substance) transferred from one device/container into another device/container cannot get trapped in dead corners of the valve and does not get accumulated in the equipment. The construction of the floating split butterfly valve of the invention provides for the fact that due to the arrangement of shafts (5, 5a) of split flaps (2, 2a) in a housing of an active and a passive part of the valve via displaceable (floating) hinges (3, 3a), seals (1, 1a) of the active and passive parts of the valve are flush with the level of the split flaps (2, 2a) on the active and passive parts, when the valve is in a closed position, while the seals (1, 1a), while in an opened position, are arranged by a distance X higher than valve housings (4, 4a) and the flaps (2, 2a) and the seals (1, 1a) remain on the same level due to clearance S1=X.

The object of the invention is a floating split, butterfly valve that allows connection of two processing devices or containers in a way that one of the devices (e. g. a transport device or a container) is closed by one half of the valve (passive part) while the other device (e. g. a stable device or a container) is closed by another half of the valve (active part), wherein the material (powder and/or liquid substance) transferred from one device/container into another device/container cannot get trapped in dead corners of the valve and does not get accumulated in the equipment. The valve and its parts can therefore be cleaned simply and efficiently (CIP—»cleaning in place«). The invention belongs to class F 16K 5/06 of the International Patent Classification.

The technical problem which is successfully solved by the floating split butterfly valve of the invention is a construction-conditioned embodiment and mounting of flaps of a split valve that prevents the seals from pulling dust particles behind the edge between the flaps and the seals, which then remain trapped in dead corners of the valve and get accumulated in the equipment.

Split butterfly valves are used in devices for dustfree gravity dosing of powder and liquid materials from one device (container) into another device (container). Such dosing principles are specifically used in chemical and pharmaceutical industries. In connecting two processing devices (containers), these valves allow that one device (container) is closed by one half of the valve, while the other device (container) is closed by another half of the valve. The active part of the valve is usually arranged on a chemical reactor, mill, sieve . . . , while the passive part of the valve is arranged on a portable container, transport mill, sieve . . . . In a connected position, the flaps are sealed on the sealing/external circumference which prevents the product from getting between the flap halves. When the flaps are in an opened position, both flaps are uncontaminated on external surfaces. If the material is to be transferred by gravity from the upper device through the passive valve into the bottom device, both valve parts must be connected. To serve this purpose the active part of the valve is provided with a rubber compensating element or a pneumatic drive and with two positioning bars to ensure proper locking. The positioning bars are provided with a cut-out eccentric curve for valve locking. Locking is carried out in a way that the tangent of the angle of the slope of the curve is smaller than the coefficient of friction to achieve self-locking (locking). To connect the active part of the split butterfly valve with the passive part of the valve, both parts need to be brought closer to each other. This is carried out by way of rough positioning by a lift or by a positioning station.

In the event that the split butterfly valve is equipped with four coupling pneumatic cylinders, rough positioning can terminate at a distance of 80 mm, while final coupling is carried out pneumatically. In the event that rubber compensating elements are used instead of pneumatic cylinders, positioning is carried out by a lift or a positioning device. The force needed to connect both valve parts is obtained through deformation of the compensating element (max. 8 mm). When both valve parts are connected, the active and passive parts need to be locked. This is done manually or by a pneumatic drive. Said curve cut into the positioning bars is used for this purpose. Split butterfly valves with a pneumatic drive are usually provided with limit switches. It can thus be detected whether the valve is connected and locked. This control function is utterly important in automated processes. Transfer of material from a portable device or container into a stable device or container is carried out in that connected flaps are simultaneously rotated by 90° by means of a manual or pneumatic drive. Here, the active flap acts on the passive flap in a way that they both open or close simultaneously. Once the transfer of material is completed, the connected flaps are first closed to the closed position. The valve is then unlocked by a pneumatic or manual drive. Finally, the portable device or container is removed to a predetermined place by means of a lift or an adequate transport means (fork lift, AGV).

When the material (powder and/or liquid substance) is transferred from one device (container) into another device (container), it gets accumulated in dead corners of conventional (existing) variants of valves. Protection of persons and environment is becoming more and more important in the production of cytostatics, hormones and other highly active medicines and chemical substances (hereinafter toxic substances). European legislation regulates basic conditions for the protection of persons at work and for the protection of the environment. The baseline rule stipulates that the equipment should be designed in a way that material (toxic substance) does not get accumulated in the equipment and does not spread into the environment. The manufacturers of chemical and pharmaceutical products are responsible for adopting such technical measures to be able to offer adequate protection. As far as toxicity levels are concerned, the recommendations regulate various limits for a daily exposure to toxic substances of workers (OEL—μg/m³) and various OEB protection levels that mechanical engineering industry can produce.

The floating butterfly valve of the invention efficiently solves the set technical problem by a construction-conditioned embodiment of a floating flap that allows the seal to be flush with the edge of the valve housing when the valve is closed, while, when the valve is opened, there is a clearance between the hinge and the split shaft S1=X. Due to the clearance S1, the seals in both valve housings lie by a distance X higher than the level of each valve housing or are flush with the level of the seals due to their pressure with a force P onto the split shafts of the butterfly valve. Hence both contact surfaces (seal-seal and flap-seal) move simultaneously and the seals do not pull dust particles in the edge between the flaps and the seals.

The invention will be explained in more detail by way of an embodiment and the belonging figures, in which:

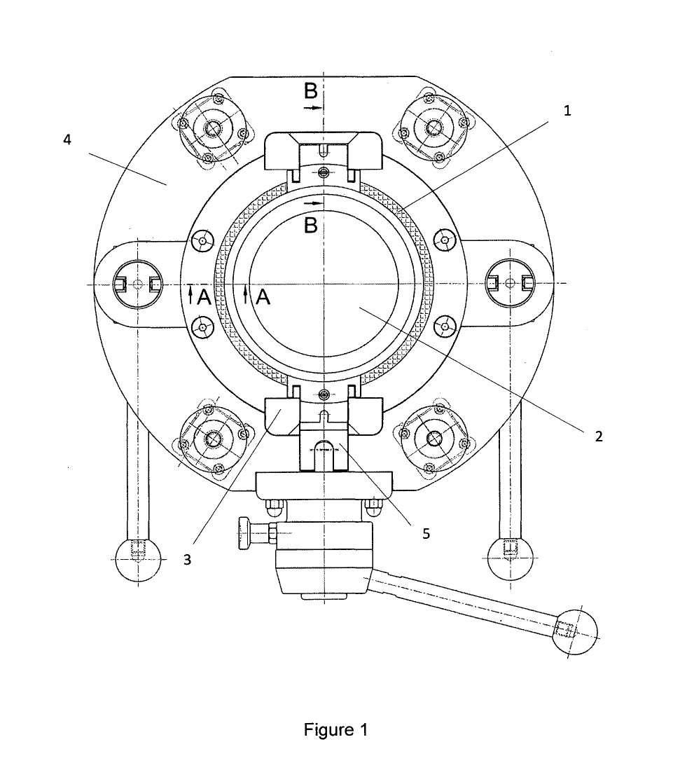

FIG. 1 shows a top view on one half of a flap valve;

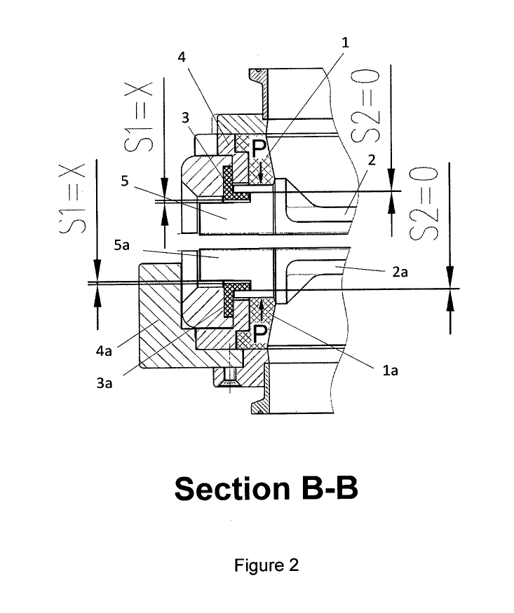

FIG. 2 shows a detail of split flaps in the open position of the valve in sectional view B-B;

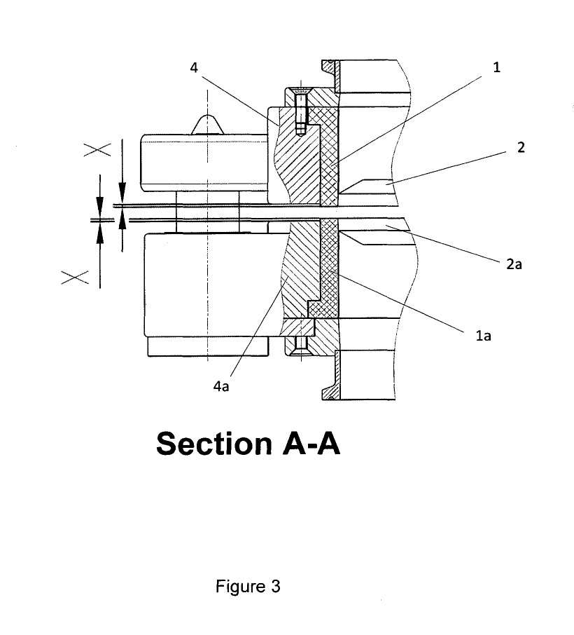

FIG. 3 shows a detail of split flaps in the open position of the valve in sectional view A-A;

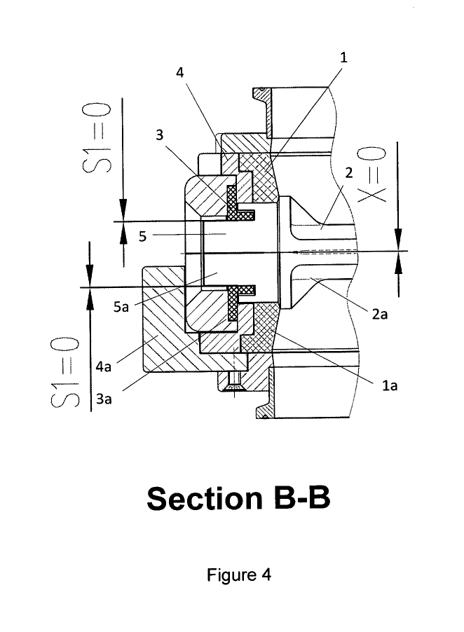

FIG. 4 shows a detail of split flaps in the closed position of the valve in sectional view B-B;

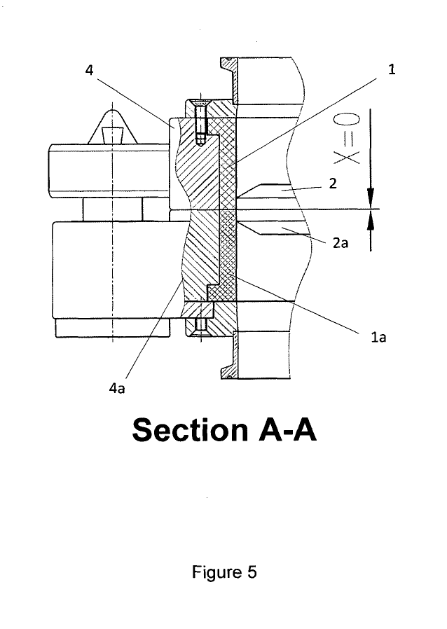

FIG. 5 shows a detail of split flaps in the closed position of the valve in sectional view A-A.

In a floating split butterfly valve of the invention, shafts 5,5a of split flaps 2,2a are arranged in a housing of an active and a passive part of the valve via displaceable (floating) hinges 3,3a, such that seals 1,1a of the active and passive parts of the valve are flush with the level of the split flaps 2,2a, when the valve is in a closed position, while the seals 1,1a, while in an opened position, are arranged by a distance X higher than valve housings 4,4a, the flaps 2,2a and the seals 1,1a remaining on the same level due to clearance S1=X. In this way, the seals 1,1a do not pull fine particles of the material being transferred (powder and/or liquid substance) into the contact edge of the flaps 2,2a and the seals 1,1a when the valve is unloaded.

In disconnecting the valve, the seals 1,1a would project from the level of the flaps 2,2a if the split flaps 2,2a had not been mounted in a displaceable (floating) manner. This would result in contamination of the surface of the contact corner between the flaps 2,2a and the seals 1,1a from the inner side by the particles pulled by the seals 1,1a.

Sealing between both flaps 2,2a is provided for by a somewhat longer seal (X), this is shown in FIG. 3. The split shafts 5,5a of the flaps 2,2a are mounted into displaceable (floating) hinges 3,3a. The force P needed to achieve adequate mounting of the split flaps 2,2a is provided for by the seals 1,1a in the opened position and during a transfer to the closed position.

When passing from the opened position to the closed position, where the seals 1,1a get compressed vertically, the position of the hinges 3,3a moves downwards by a distance equal to the distance of compression of the seals 1,1a (height S1=X). This fact provides for frontal alignment of the split flaps 2,2a with the seals 1,1a.

In the closed position, the position of the split shafts 5,5a of the flaps 2,2a is conditioned by the geometry of the hinges 3,3a and the geometry of the split flaps 2,2a.

To provide a more precise understanding of the function of the floating flaps 2,2a, FIGS. 2, 3 and 4, 5 show the arrangement of the floating split flaps 2,2a.

In the opened position of the split flaps 2,2a of the flap valve, FIGS. 2 and 3 show a detail of mounting of the floating flaps 2,2a in the displaceable (floating) hinges 3,3a. The seals 1,1a exert pressure in direction of the force P onto the shafts 5,5a of the flaps 2,2a. The radius of the split shafts 5,5a of the flaps 2,2a corresponds to the radius of the hinges 3,3a, such that there is no clearance between the hinges 3,3a and the split shafts 5,5a, S2=0.

Although the seals 1,1a lie higher than the housings 4,4a of the active and passive parts of the valve by the distance X, the seals 1,1a and the flaps 2,2a are flush due to the force P and the geometry of the hinges 3,3a and of the shafts 5,5a.

In the closed position of the split flaps 2,2a of the flap valve, FIGS. 4 and 5 show a detail of mounting of the flaps 2,2a with the displaceable (floating) hinges 3,3a.

The seals 1,1a are deformed by X+X and the split flaps 2,2a are in a closed position as shown in FIG. 5.

Both parts of the split shaft 5,5a of the flaps 2,2a match the inner diameter of the hinges 3,3a, so there is clearance S1=X=0 between the hinges 3,3a and the split shafts 5,5a. This is shown in FIG. 4.

The floating split butterfly valve sufficiently solves the set technical problem by way of the above-described arrangement of both parts of the split shafts 5,5a of the flaps 2,2a, such that clearance occurs between the hinges 3,3a and the split shafts 5,5a, said clearance providing for the fact that, when the flap valve is in the opened position, the seals 1,1a in both valve housings 4,4a lie by the distance X higher than the edge of each valve housing 4,4a, while the seals 1,1a are flush with the edge of each housing 4,4a, when the valve is in the closed position.

1. A floating split butterfly valve
characterized in that
shafts (5,5a) of split flaps (2,2a) are arranged in a housing of an active and a passive part of the valve via displaceable hinges (3,3a), such that seals (1,1a) of the active and passive parts of the valve are flush with the level of the split flaps (2,2a), when the valve is in a closed position, while the seals (1,1a), while in an opened position, are arranged by a distance X higher than valve housings (4,4a), the flaps (2,2a) and the seals (1,1a) remaining on the same level due to clearance S1=X.
